(19) United States
(12) Patent Application Publication
(10) Pub. No.: US 2007/0150705 A1
(43) Pub. Date: Jun. 28, 2007

(54) Efficient counting for iterative instructions

(75) Inventors: Michael Mishaeli, Zichron (IL); Ittai Anati, Haifa (IL)

Correspondence Address: CAVEN & AGHEVLI;c/o INTELLEVATE, P.O. BOX 52050, MINNEAPOLIS, MN, 55402, US

(73) Assignee: Intel Corporation

(21) Appl. No.: 11/320,262

(22) Filed: Dec. 28, 2005

(51) Int. Cl. G06F 9/30

(52) U.S. Cl. 712/218

(57) ABSTRACT

Methods and apparatus to provide efficient counting of the number of retired iterations of an iterative instruction are described. In one embodiment, the number of retired iterations of an iterative instruction is determined.

### BACKGROUND

The present disclosure generally relates to the field of electronics. More particularly, an embodiment of the invention relates to counting the number of retired iterations of an iterative instruction.

When a processor executes an iterative instruction, the execution may be stopped prior to completion of all iterations of the iterative instruction, e.g., due to an error. To complete the processing of the iterative instruction, the processor may re-execute the iterative instruction. This results in performance degradation.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a system, according to an embodiment of the invention.

FIGS. 2A and 2B illustrate block diagrams of portions of a processor core, according to various embodiments of the invention.

FIG. 3 illustrates a flow diagram of a method to determine the number of retired iterations of an iterative instruction, according to an embodiment.

FIGS. 4 and 5 illustrate block diagrams of computing systems in accordance with various embodiments of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

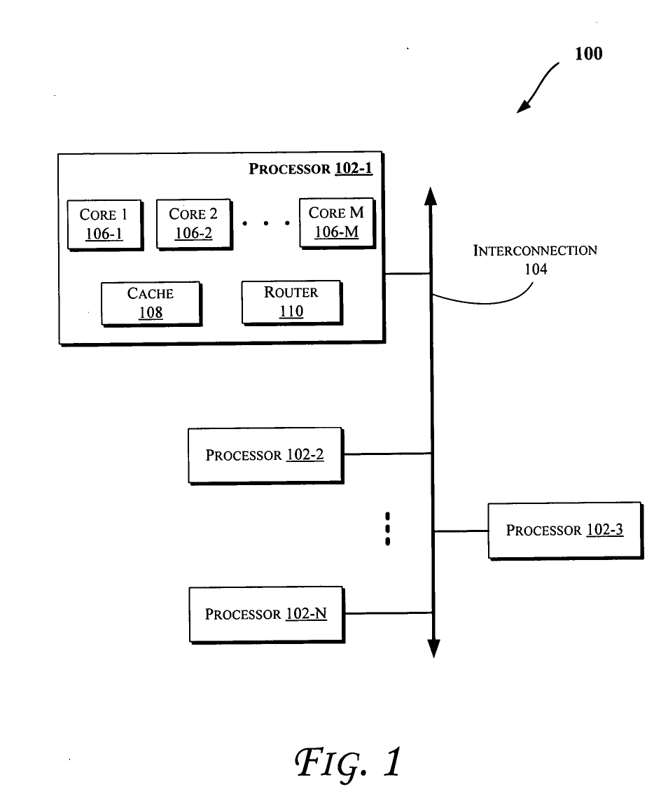

Some of the embodiments discussed herein (e.g., with reference to FIGS. 1-5) may provide efficient mechanisms for determining the number of retired iterations of an iterative instruction. In an embodiment, this information may be used to resume processing of an iterative instruction from a point that corresponds to the last successful retired iteration, rather than re-executing all iterations of the iterative instruction. Moreover, the techniques discussed herein may be applied in various hardware architectures, such as those discussed with reference to FIGS. 1-5. More particularly, FIG. 1 illustrates a block diagram of a system 100, according to an embodiment of the invention. The system 100 may include one or more processors 102-1 through 102-N (referred to herein as “processors 102” or more generally as “processor 102”). The processors 102 may communicate via an interconnection network or bus 104. Each of the processors may include various components some of which are only discussed with reference to processor 102-1 for clarity. Accordingly, each of the remaining processors 102-2 through 102-N may include the same or similar components discussed with reference to the processor 102-1. Additionally, the embodiments discussed herein are not limited to multiprocessor computing systems and may be applied in a single-processor computing system.

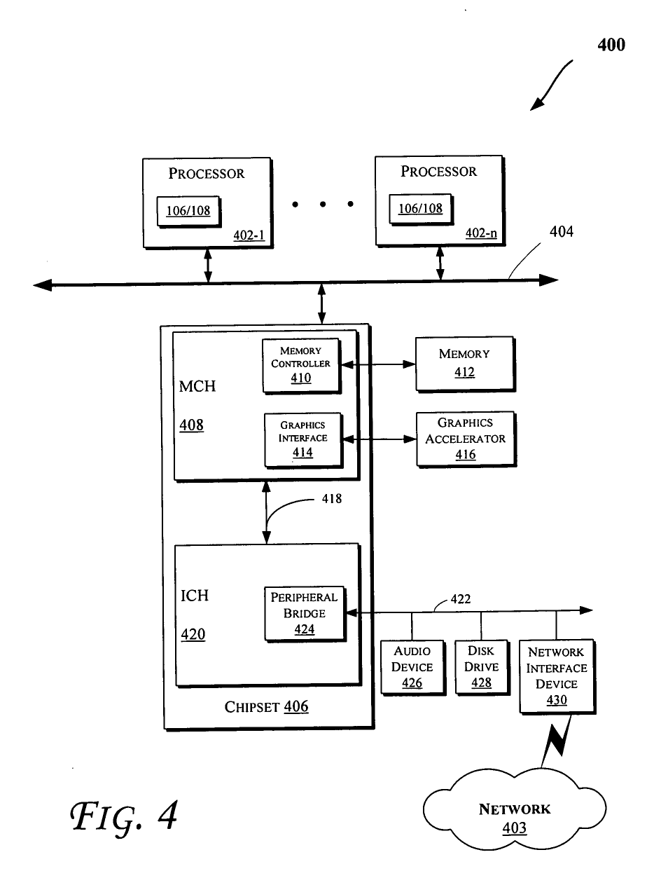

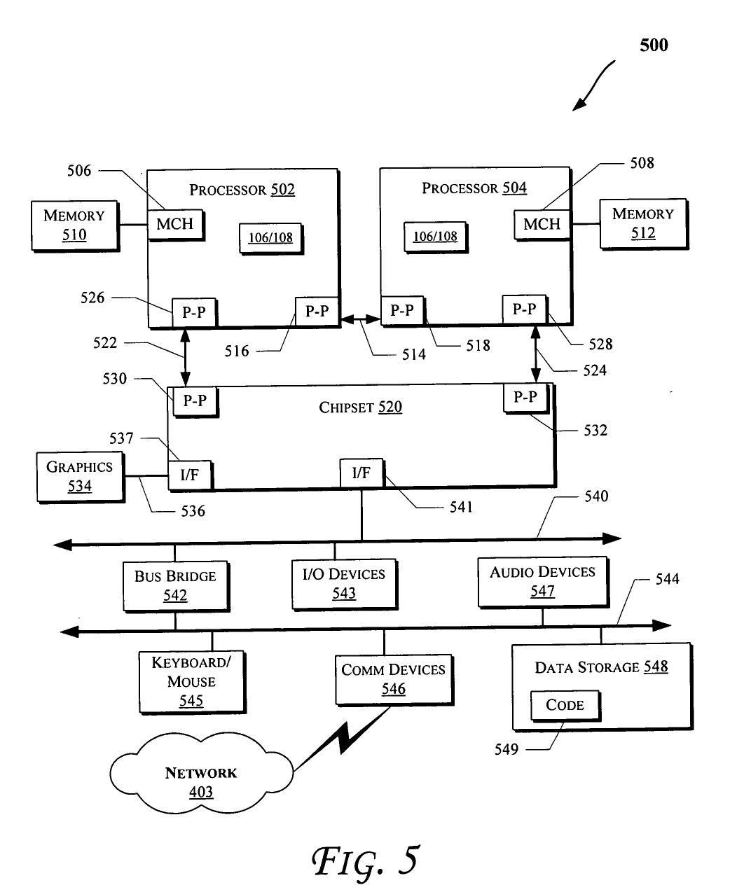

In an embodiment, the processor 102-1 may include one or more processor cores 106-1 through 106-M (referred to herein as “cores 106” or more generally as “core 106”), a cache 108, and/or a router 110. The processor cores 106 may be implemented on a single integrated circuit chip. Moreover, the chip may include one or more shared or private caches (such as cache 108), interconnects (such as 104), memory controllers (such as those discussed with reference to FIGS. 4 and 5), or other components.

In one embodiment, the router 110 may be used to communicate between various components of the processor 102-1 and/or system 100. Moreover, the processor 102-1 may include more than one router 110. Furthermore, the multitude of routers (110) may be coupled to enable data routing between various components inside or outside of the processor 102-1.

The cache 108 may store data (e.g., including instructions) that are utilized by one or more components of the processor 102-1. In an embodiment, the cache 108 (that may be shared) may include one or more of a level 2 (L2) cache, a last level cache (LLC), or other types of cache. Various components of the processor 102-1 may communicate with the cache 108 directly, through a bus, and/or memory controller or hub. Also, the processor 102-1 may include more than one cache (108). In one embodiment, the cores 106 may additionally include a level 1 (L1) cache.

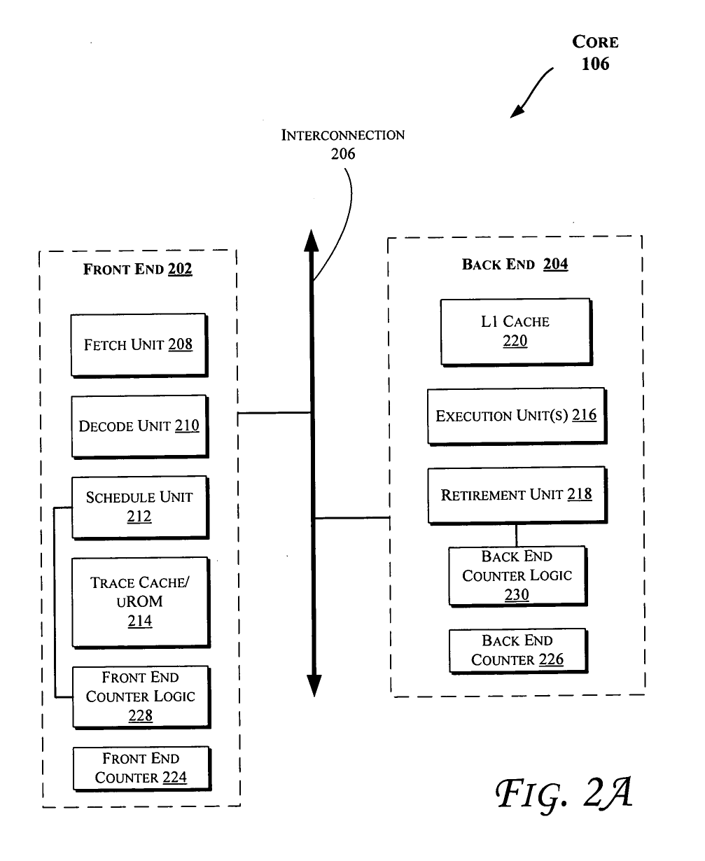

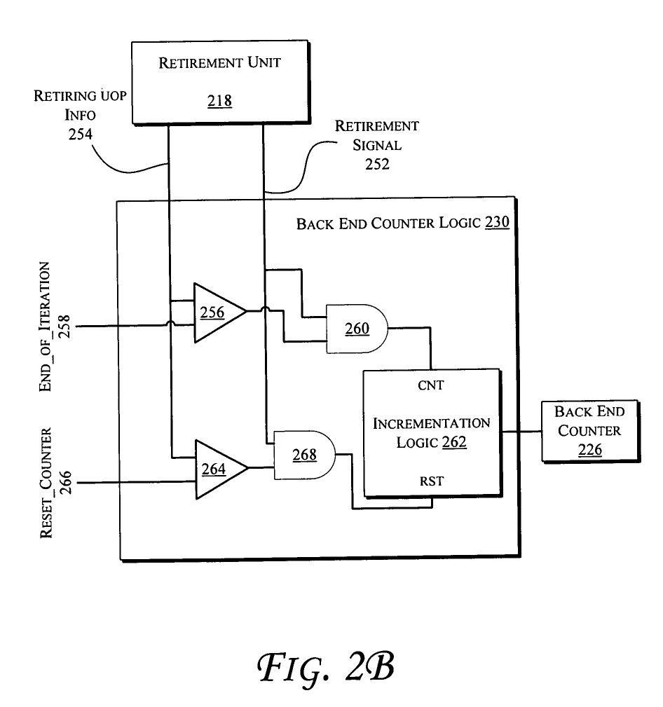

FIG. 2A illustrates a block diagram of portions of a processor core 106, according to an embodiment of the invention. One or more processor cores (such as the processor core 106) may be implemented on a single integrated circuit chip (or die) such as discussed with reference to FIG. 1. Moreover, the chip may include one or more shared or private caches, interconnects, memory controllers, or other components.

As illustrated in FIG. 2A, the processor core 106 may include a front end 202, a back end 204, and an interconnection 206 (e.g., to communicate data (for example, including instructions) between various components of the core 106). The front end 202 may include a fetch unit 208 to fetch instructions for execution by the core 106. The instructions may be fetched from any storage devices such as the memory devices discussed with reference to FIGS. 4 and 5. The front end 202 may also include a decode unit 210 to decode the fetched instruction. For instance, the decode unit 210 may decode the fetched instruction into a plurality of uops (micro-operations). The front end 202 may further include a schedule unit 212. The schedule unit 212 may perform various operations associated with storing decoded instructions (e.g., received from the decode unit 210) until they are ready for dispatch, e.g., until all source values of a decoded instruction become available. In one embodiment, the schedule unit 212 may schedule and/or issue (or dispatch) decoded instructions to various components of the processor core 106 for execution, such as components of the back end 204.

As shown in FIG. 2A, the front end 202 may also include a trace cache or microcode read-only memory (uROM) 214 to store microcode and/or traces of instructions that have already been fetched (e.g., by the fetch unit 208). The microcode stored in the uROM 214 may be utilized to configure various hardware components of the processor core 106 (e.g., such that the hardware may execute an instruction). In an embodiment, the microcode stored in the uROM 214 may be loaded from another component in communication with the processor core 106, such as a computer-readable medium or other storage device discussed with reference to FIGS. 4 and 5.

The back end 204 may include a level 1 (L1) cache 220, one or more execution units 216, and a retirement unit 218. The execution unit 216 may execute the dispatched instructions after they are decoded (e.g., by the decode unit 210) and dispatched (e.g., by the schedule unit 212). In one embodiment, the execution unit 216 may include more than one execution unit (not shown), such as a memory execution unit, an integer execution unit, a floating-point execution unit, or other execution units. The execution unit(s) 216 may execute instructions out-of-order; hence, the processor core 106 may be an out-of-order processor core in one embodiment. The retirement unit 218 may retire instructions after they are executed. In an embodiment, retirement of the executed instructions may result in processor state being committed from the execution of the instructions, physical registers used by the instructions being de-allocated, etc. In one embodiment, the trace cache 214 may store instructions either after they have been decoded by the decode unit 210, or as they are retired by the retirement unit 218.

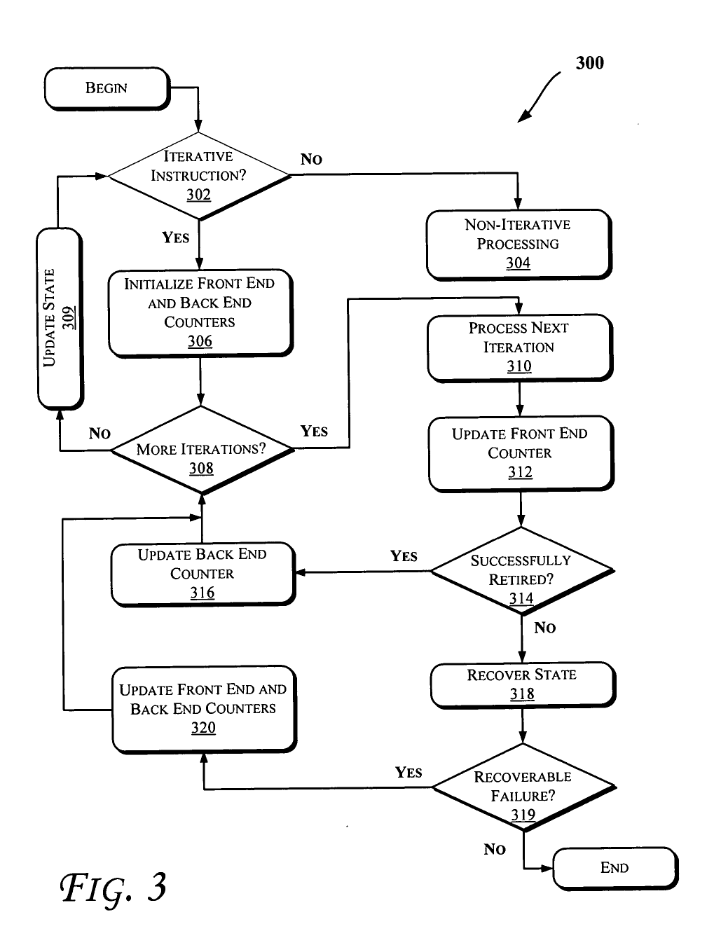

As illustrated in FIG. 2A, the processor core 106 may also include a front end counter 224 and a back end counter 226. The counters 224 and 226 may be utilized to store the number of fetched and retired iterations of an iterative instruction, respectively, as is further discussed herein, e.g., with reference to FIG. 3. The counters 224 and 226 may be maintained (e.g., initialized and/or updated) by front end counter logic 228 and back end counter logic 230, respectively. Moreover, the counters 224 and 226 may be implemented as hardware registers and/or variables stored in shared memory in various embodiments. In an embodiment, the counters 224 and 226 may be implemented as variables stored in the trace cache 214.

FIG. 2B illustrates a block diagram of portions of the processor core 106, according to an embodiment of the invention. More particularly, FIG. 2B illustrates further details regarding portions (e.g., the back end counter logic 230) of the processor core 106 of FIG. 2A. In one embodiment, logic within the retirement unit 218 may generate one or more signals that are provided to the back end logic counter 230, including a retirement indicator signal 252 (e.g., which may indicate whether a uop (or instruction) has successfully retired) and/or a retiring uop (or instruction) information signal 254 (e.g., which may include one or more bits that correspond to the opcode of the retiring uop).

As shown in FIG. 2B, the back end counter logic 230 may include a comparator 256 to compare the retiring uop information signal 254 and an end₁₃of₁₃iteration signal 258 (e.g., which may correspond to the opcode of a last uop of an iteration of an iterative instruction). An AND gate 260 may logically AND the output of the comparator 256 and the retirement indicator signal 252 to provide a signal to an incrementation logic 262 to indicate that the back end counter 226 is to be incremented. Hence, if a last uop of an iterative instruction (e.g., as determined by the comparator 256) is successfully retired (e.g., as indicated by signal 252), the incrementation logic 262 may increment the back end counter 226. In an embodiment, the back end counter 226 may be incremented by one (or more than one if more than one iteration retires in the same cycle).

The back end counter logic 230 may also include a comparator 264 to compare the retiring uop information signal 254 and a reset₁₃counter signal 266 (e.g., where the reset₁₃counter signal 266 may correspond to the opcode of a uop of an iterative instruction and the uop is executed before or after a loop corresponding to the iterative instruction). As illustrated in FIG. 2B, an AND gate 268 may logically AND the output of the comparator 264 and the retirement indicator signal 252 to provide a signal to the logic 262 to indicate that the back end counter 226 is to be reset, as will be further discussed with reference to the operations of FIG. 3. In one embodiment, the back end counter logic 230 may include one or more flip-flops to synchronize the timing between various signals. In an embodiment, the decode unit 210 may generate the values provided by the signals 258 and/or 266, e.g., as part of decoding an iterative instruction. In one embodiment, the values provided by the signals 258 and/or 266 may be stored in hardware registers. Further, the values provided by the signals 258 and/or 266 may be constant values, e.g., provided by a voltage source or ground signal.

FIG. 3 illustrates a flow diagram of a method 300 to determine the number of retired iterations of an iterative instruction, according to an embodiment. In one embodiment, the operations of the method 300 may be performed by one or more components of a processor, such as the components discussed with reference to FIGS. 1-2B. Additionally, microcode (e.g., stored in the uROM 214) may be utilized to configure various components discussed with reference to FIGS. 1-2B to perform the operations of FIG. 3. In some embodiments, the method 300 may be performed in a single clock cycle of the processor core 106 of FIGS. 1-2A.

Referring to FIGS. 1-3, an operation 302 determines whether an instruction (e.g., fetched by the fetch unit 208 and/or decoded by decode unit 210) is iterative. An iterative instruction generally refers to an instruction that requests the execution of an operation more than one time, e.g., for a select number of iterations. Each operation (or iteration) may include one or more uops in an embodiment. For example, according to at least one instruction set architecture, “REP MOVSW” instruction may identify the length of a string to be moved and two memory pointers that point to different regions of memory. The hardware executing the instruction (such as the core 106 of FIGS. 1-2A) may then copy a block of words (e.g., 2 bytes) in memory (of the specified string length) from one memory region to another memory region. In an embodiment, the operation 302 may be performed by the decode unit 210. If the fetched instruction is non-iterative, the method 300 continues with non-iterative processing of the fetched instruction at an operation 304.

If the operation 302 determines that the fetched instruction is iterative, the front end counter 224 and back end counter 226 are initialized at an operation 306. For example, the front end counter 224 may be initialized to the number of iterations (or loops) that correspond to the iterative instruction (e.g., as identified by a parameter of the iterative instruction) and the back end counter 226 may be initialized to zero (“0”), such as discussed with reference to FIGS. 2A and 2B. If no more iterations remain (308), the state of various components of the processor core 106 (e.g., one or more architectural registers) may be updated (309), and the method 300 continues with the next operation (302). Otherwise, the processor core 106 processes one or more uops corresponding to the next iteration (310), e.g., decodes, schedules, executes, and/or retires the uop(s) of the next iteration, such as discussed with reference to FIG. 2A. Operation 312 updates the front end counter (e.g., by decrementing it by one in an embodiment). If an iteration (e.g., the last uop of the iteration in an embodiment) is successfully retired (314) (for example, by the retirement unit 218), the back end counter may be updated (316), such as discussed with reference to FIG. 2B. Hence, the back end counter 226 may be updated (e.g., incremented by one, or more than one, in various embodiments) for each successful retirement of an iteration of the iterative instruction (316) in an embodiment (e.g., after the retirement of the last uop of an iteration). As discussed with reference to FIG. 2A, the core 106 may be an out-of-order processor core and, as a result, operations performed by the front end 202 (e.g., operations 308, 310, and/or 312) may run ahead and be performed on several subsequent iterations before the back end 204 of the core 106 performs its operations (e.g., operation 314) on each of the iterations that arrive at the back end 204. After operation 316, the method 300 continues with the operation 308, e.g., for a next iteration.

Otherwise, if a uop (e.g., corresponding to the iteration of the operation 310) fails to retire (314), an operation 318 may use the value stored in the back end counter 226 to update (or recover) the state of various components of the processor core 106 (e.g., one or more architectural registers) in accordance with the actual number of iterations that have previously retired. In an embodiment, the operation 318 may modify the state of various components of the processor core 106. In an embodiment, an error signal generation logic (e.g., which may be incorporated within the retirement unit 218 (not shown)) to generate an error signal to indicate that a uop has failed to retire. The error signal may then be detected by one or more components of the processor core 106 (such as the schedule unit 212 and/or the microcode stored in the uROM 214) that will perform the operation 318. In various embodiments, a uop may fail to retire for one or more reasons such as an exception, an interrupt, a fault, a microcode assist, combinations thereof, or other reasons.

At an operation 319, it is determined whether the failure to retire at operation 314 is due to an error that may not be recoverable by the core 106. If the core 106 is unable to recover from the failure (e.g., due to a memory related fault), the method 300 terminates. Otherwise, if the core 106 is able to recover from the failure (also referred to as an “assist”), e.g., from a split page access, the method 300 may continue with an operation 320. The operation 320 may update the front end counter 224 and the back end counter 226 prior to continuing with the operation 308. For example, the back end counter 226 may be initialized to zero (“0”). Also, the front end counter 224 may be initialized to the updated number of remaining iterations (e.g., because the value of the front end counter 224 may have been modified in accordance with speculative processing). In one embodiment, the front end counter 224 may be initialized to a value that is the original number of iterations identified by the iterative instruction subtracted by the value of the back end counter 226 (that indicates the number of retired iterations). Moreover, the operations 318 and 320 may be performed simultaneously in an embodiment.

In various embodiments, one or more of the operations 306, 308, 312, 318, and/or 320 may be performed in accordance with microcode, and/or performed by the front end counter logic 228 and the back end counter logic 230. For example, the front end counter logic 228 may communicate with the schedule unit 212 to determine when and/or whether to update the front end counter 224 at operation 312. Also, the back end counter logic 230 may communicate with the retirement unit 218 to determine whether a uop has retired, and when and/or whether to update the back end counter 226 at operation 316. Additionally, the retirement unit 218 may determine when a uop has failed to retire and generate an error signal after operation 314. Alternatively, microcode (e.g., stored in the uROM 214) may configure components of the schedule unit 212 (or a microcode sequencer in the front end 202 (not shown)) to perform the operations discussed with reference to the front end counter logic 228. Also, microcode (e.g., stored in the uROM 214) may configure components of the retirement unit 218 to perform the operations discussed with reference to the back end counter logic 230.

FIG. 4 illustrates a block diagram of a computing system 400 in accordance with an embodiment of the invention. The computing system 400 may include one or more central processing unit(s) (CPUs) 402 or processors that communicate via an interconnection network (or bus) 404. The processors (402) may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, one or more of the processors 402 may be the same or similar to the processors 102 of FIG. 1. For example, one or more of the processors 402 may include one or more of the cores 106 and/or cache 108. Also, at least some of the operations discussed with reference to FIGS. 1-3 may be performed by one or more components of the system 400.

A chipset 406 may also communicate with the interconnection network 404. The chipset 406 may include a memory control hub (MCH) 408. In an embodiment, the MCH 408 may be implemented in the processors 402. The MCH 408 may include a memory controller 410 that communicates with a memory 412. The memory 412 may store data, e.g., including sequences of instructions that are executed by the CPU 402, or any other components included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The MCH 408 may also include a graphics interface 414 that communicates with a graphics accelerator 416. In an embodiment, the graphics accelerator 416 may be outside of the chipset 406, e.g., implemented in the processors 402. In one embodiment of the invention, the graphics interface 414 may communicate with the graphics accelerator 416 via an accelerated graphics port (AGP). In an embodiment of the invention, a display (such as a flat panel display) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 418 may allow communication between the MCH 408 and an input/output control hub (ICH) 420. The ICH 420 may provide an interface to I/O devices that communicate with the computing system 400. For example, the ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device 430 (which is in communication with the computer network 403). Other devices may communicate via the bus 422. Also, various components (such as the network interface device 430) may communicate with the MCH 408 in some embodiments of the invention. In addition, the processor 4 02 and the MCH 408 may be combined to form a single chip. Furthermore, the graphics accelerator 416 may be included within the MCH 408 in other embodiments of the invention.

Additionally, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 412.

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a high-performance graphics circuit 534 via a high-performance graphics interface 536, e.g., using a PtP interface circuit 537.

At least one embodiment of the invention may be provided within the processors 502 and 504. For example, one or more of the cores 106 and/or cache 108 of FIGS. 1-2A may be located within the processors 502 and 504. Other embodiments of the invention, however, may exist in other circuits, logic units, or devices within the system 500 of FIG. 5. Furthermore, other embodiments of the invention may be distributed throughout several circuits, logic units, or devices illustrated in FIG. 5.

The chipset 520 may communicate with a bus 540 using a PtP interface circuit 541. The bus 540 may have one or more devices that communicate with it, such as a bus bridge 542 and I/O devices 543. Via a bus 544, the bus bridge 543 may communicate with other devices such as a keyboard/mouse 545, communication devices 546 (such as modems, network interface devices, or other communication devices that may communicate with the computer network 403), audio I/O device, and/or a data storage device 548. The data storage device 548 may store code 549 that may be executed by the processors 502 and/or 504.

In various embodiments of the invention, the operations discussed herein, e.g., with reference to FIGS. 1-5, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A processor comprising:
a retirement unit to retire one or more uops corresponding to an iterative instruction and to generate a retirement signal to indicate successful retirement of an iteration corresponding to the iterative instruction;
a counter to store a number of retired iterations of the iterative instruction; and
counter logic to update the counter based on the retirement signal.

2. The processor of claim 1, wherein the counter logic updates the counter based on the retirement signal and a comparison of an opcode of a retiring uop and a stored value.

3. The processor of claim 2, wherein the stored value corresponds to an opcode of a last uop of an iteration of the iterative instruction.

4. The processor of claim 1, further comprising logic to recover a state of one or more components of the processor based on a value stored in the counter after a uop corresponding to the iterative instruction fails to retire.

5. The processor of claim 1, further comprising a comparator to compare an opcode of a retiring uop and a stored value, wherein the counter logic updates the counter based on the retirement signal and an output of the comparator.

6. The processor of claim 5, further comprising an incrementation logic to increment the counter based on the retirement signal and the output of the comparator.

7. The processor of claim 1, further comprising a comparator to compare an opcode of a retiring uop and a stored value, wherein the counter logic resets the counter based on the retirement signal and an output of the comparator.

8. The processor of claim 7, wherein the stored value corresponds to an opcode of a uop of the iterative instruction and wherein the uop is executed before or after a loop corresponding to the iterative instruction.

9. The processor of claim 1, wherein the counter logic increments or decrements the counter.

10. The processor of claim 1, further comprising error signal generation logic to generate an error signal after a uop corresponding to the iterative instruction fails to retire.

11. The processor of claim 1, further comprising a fetch unit to fetch the iterative instruction from a memory.

12. The processor of claim 1, further comprising logic to modify a state of one or more components of the processor.

13. The processor of claim 1, further comprising a front end counter to store a number of iterations of the iterative instruction that remain to be processed.

14. The processor of claim 13, further comprising a front end counter logic to update the front end counter.

15. The processor of claim 1, further comprising a plurality of processor cores.

16. The processor of claim 15, wherein the plurality of processor cores reside on a same die.

17. The processor of claim 1, further comprising one or more caches to store data.

18. A method comprising:
generating a retirement signal to indicate successful retirement of an iteration corresponding to an iterative instruction;
storing a number of retired iterations of an iterative instruction; and
updating the stored number of retired iterations in response to the retirement signal.

19. The method of claim 18, wherein updating the stored number of retired iterations further comprises comparing an opcode of a retiring uop with one or more stored values.

20. The method of claim 18, wherein updating the stored number of retired iterations comprises incrementing or decrementing the stored number.

21. The method of claim 18, further comprising generating an error signal after a uop corresponding to the iterative instruction fails to retire.

22. The method of claim 18, further comprising incrementing a counter based on the retirement signal.

23. The method of claim 18, further comprising recovering a state of one or more components of a processor based on the stored number of retired iterations after a uop corresponding to the iterative instruction fails to retire.

24. A system comprising:
a memory to store at least one iterative instruction; and
at least one processor core comprising:
an execution unit to execute the iterative instruction; and
logic to increment a counter each time a last uop of an iteration of the iterative instruction retires.

25. The system of claim 24, further comprising logic to recover a state of one or more components of the processor core based on a value stored in the counter after a uop of the iterative instruction fails to retire.

26. The system of claim 24, further comprising a fetch unit to fetch the iterative instruction from the memory.

27. The system of claim 24, further comprising an audio device.

28. The system of claim 24, further comprising error signal generation logic to generate an error signal after a uop of the iterative instruction fails to retire.

29. The system of claim 24, further comprising a comparator to compare an opcode of a retiring uop and a stored value.

30. The system of claim 24, further comprising a front end counter to store a number of iterations of the iterative instruction that remain to be processed.

31. An apparatus comprising:
a first logic to generate a retirement signal to indicate successful retirement of an instruction; and
a second logic to count a number of times the instruction is retired based on the retirement signal.

32. The apparatus of claim 31, further comprising an error generation logic to generate an error signal after a uop corresponding to the instruction fails to retire.

33. The apparatus of claim 32, further comprising a third logic to recover a state of one or more components of a processor in response to the error signal and based on the counted number of times the instruction is retired.

34. The apparatus of claim 31, wherein the second logic comprises a counter to store the counted number of times the instruction is retired.

35. The apparatus of claim 31, further comprising a plurality of processor cores.
